(19) United States
(12) Patent Application Publication
(10) Pub. No.: US 2005/0135727 A1
(43) Pub. Date: Jun. 23, 2005

(54) EMI-EMC shield for silicon-based optical transceiver

(75) Inventors: David Piede, Allentown, PA (US); Margaret Ghiron, Allentown, PA (US); Prakash Gothoskar, Allentown, PA (US); Robert Keith Montgomery, Easton, PA (US); Vipulkumar Patel, Monmouth Junction, NJ (US); Kalpendu Shastri, Orefield, PA (US); Soham Pathak, Allentown, PA (US); Katherine A. Yanushefski, Zionsville, PA (US)

Correspondence Address: Wendy W. Koba, PO Box 556, Springtown, PA, 18081, US

(73) Assignee: SiOptical, Inc., Allentown, PA (US)

(21) Appl. No.: 11/013,722

(22) Filed: Dec. 16, 2004

Related U.S. Application Data
(60) Provisional application No. 60/530,520, filed on Dec. 18, 2003.

(51) Int. Cl. G02B 6/12

(52) U.S. Cl. 385/14

(57) ABSTRACT

An SOI-based opto-electronic structure includes various electronic components disposed with their associated optical components within a single SOI layer, forming a monolithic arrangement. EMI/EMC shielding is provided by forming a metallized outer layer on the surface of an external prism coupler that interfaces with the SOI layer, the metallized layer including transparent apertures to allow an optical signal to be coupled into and out of the SOI layer. The opposing surface of the prism coupler may also be coated with a metallic material to provide additional shielding. Further, metallic shielding plates may be formed on the SOI structure itself, overlying the locations of EMI-sensitive electronics. All of these metallic layers are ultimately coupled to an external ground plane to isolate the structure and provide the necessary shielding.

### CROSS-REFERENCE TO RELATED APPLICATION

The present application claims the benefit of Provisional Application No. 60/530,520, filed Dec. 18, 2003.

### TECHNICAL FIELD

The present invention relates to EMI-EMC shielding for opto-electronic circuits and, more particularly, to the provision of a shielding arrangement for a silicon-based opto-electronic circuits formed within a silicon-on-insulator (SOI) structure.

### BACKGROUND OF THE INVENTION

Optical transmitters and receivers are widely used in various communication applications, such as for Local Area Networks (LANs). An optical transmitter typically produces either analog or digital optical signals based upon input electrical signals. Similarly, an optical receiver receives optical input signals and produces electrical output signals. For many applications, two-way communications are desirable. Accordingly, an optical transmitter and receiver may be paired within a housing and thus be defined as an “optical transceiver module”. In a number of instances, a relatively large number of such two-way communication links may be required (providing a desired “high port density”).

Unfortunately, as the speed and/or operating frequencies of the optical transmitter and receiver continue to increase, electromagnetic interference (EMI) may be coupled between the transmitter and receiver electrical circuit arrangements. The EMI (or noise) difficulties may become more severe as the sizes of the circuit boards and components are reduced in an effort to increase the port density. Optical receiver sensitivities for bit error rates (BER) of 1×10⁻¹² are on the order of a few μA of photocurrent at speeds greater than 1 Gb/s, while drive voltages for the optical transmitter are anywhere from a few hundred millivolts up to the power supply voltage (several volts). These transmitter drive voltages emit a high amount of electromagnetic radiation. This fact, coupled with the close proximity of the transmitter to the receiver, has been found to significantly degrade the receiver sensitivity. In addition, the transmitter drive voltages can cause performance degradation in electronic devices external to the transceiver itself. One arrangement for addressing the problem of EMI (as well as electromagnetic compatibility—EMC) is described in U.S. Pat. No. 6,369,924, issued to R. M. Scharf et al. on Apr. 9, 2002. In this arrangement, the optical transmitter portion and the optical receiver portion are formed on separate circuit boards, with an EMI shield positioned between the two boards. The circuit boards are particularly positioned “back-to-back”, with the vertical EMI shield placed therebetween. Thus, shielding between the transmitter circuit and the receiver circuit is achieved, with the vertical orientation reducing the overall dimensions of the transceiver module.

U.S. Pat. No. 6,497,588 issued to Scharf et al. on Dec. 24, 2002 discloses a somewhat different arrangement, where both the transmitter electronics and receiver electronics are mounted on the same circuit board, thus further reducing the overall size of the transceiver module. In this arrangement, the transmitter electronics are formed on a first major surface of the circuit board and the receiver electronics are formed on the opposing (second) major surface. A metallic layer is embedded within the circuit board thickness (during fabrication of the board itself), and is used to provide EMI shielding between the two circuits.

While both of these arrangements represent an advance in the art, various opto-electronic components will be based on silicon-on-insulator (SOI) structures, where various electronic circuits are integrated within the same silicon surface layer of the SOI structure. The various physical arrangements for dividing and shielding the circuits to minimize EMI, as disclosed above, cannot be used in such a situation where a planar, monolithic transceiver circuit is formed.

Thus, a need remains in the art for an arrangement for providing EMI-EMC shielding for an opto-electronic circuit formed within an SOI structure.

### SUMMARY OF THE INVENTION

The need remaining in the prior art is addressed by the present invention, which relates to EMI/EMC shielding for opto-electronic circuits and, more particularly, to the provision of a shielding arrangement for silicon-based circuits formed within a silicon-on-insulator (SOI) structure.

In accordance with the present invention, a metallic shielding structure is disposed as an outer surface layer on the optical coupling element used to couple a free space beam into and out of an opto-electronic circuit formed in an SOI structure. In particular, a metallized layer is formed on the surface of the optical coupling element that interfaces with the SOI structure, where the metallized layer is coupled to a ground plane of the SOI structure to provide the requisite shielding. The metallized layer may comprise a single, continuous layer or, alternatively, may be formed as at least two separate sections, one overlying (for example) a transmitter area on the SOI structure and the other overlying (for example) a receiver area on the SOI structure. The thickness of this metallized layer, as well as the spacing between the optical coupling element and the SOI structure, needs to be well-controlled in order for efficient evanescent optical coupling to occur. Obviously, transparent apertures must be formed in this metallized layer to allow for the passage of optical signals. A second metallized layer (also including the necessary apertures), formed to cover the top surface of the optical coupling element, may be used to provide additional EMI/EMC shielding.

In another embodiment of the present invention, additional EMI/EMC shielding is provided by including an RF ground plane shielding layer(s) on the surface of the SOI structure itself, particularly disposed to shield the sensitive electronic circuitry formed within the SOI layer. Indeed, an RF shield over receiver electronics may be used to improve its sensitivity by shielding the circuit from the radiation emitted by other circuit components such as, for example, a transmitter circuit. In this case, an RF shield over the transmitter circuit will further improve the operation of the transceiver. These shields also need to be coupled to the SOI ground plane. The shielding may be further improved by forming metallized vias through the SOI structure to provide a low impedance contact between the metallized layers and the ground plane.

An advantage of the arrangement of the present invention is the ability to utilize wafer-to-wafer bonding to provide both the necessary optical coupling and electrical connection between the SOI structure and the optical coupling element, as well as the EMI/EMC shielding.

Other and further aspects and advantages of the present invention will become apparent during the course of the following discussion and by reference to the accompanying drawings.

### BRIEF DESCRIPTION OF THE DRAWINGS

Referring now to the drawings,

FIG. 1 is a cut-away side view of an SOI structure and associated optical coupling element, illustrating the formation of a metallized layer on the coupling element surface in contact with the SOI structure;

FIG. 2 is a top view of the arrangement of FIG. 1;

FIG. 3 is an illustration of a specific portion of the electrical connection between the SOI structure and optical coupling element, showing the deformation possible in the electrical bond so as to achieve the desired spacing for evanescent optical coupling;

FIG. 4 is a cut-away side view of an alternative embodiment of the present invention, including an outer metallic layer formed over the optical coupling element;

FIG. 5 is a top view of the arrangement of FIG. 4;

FIG. 6 is a side view of the present invention, illustrating in particular the location of transparent apertures in the metallized layer of the optical coupling element that are required to provide an optical signal path;

FIG. 7 is a top view of the arrangement of FIG. 6;

FIG. 8 is a top view of an exemplary SOI structure including additional EMI shielding layers in accordance with the present invention;

FIG. 9 is a cut-away side view of the arrangement of FIG. 8;

FIG. 10 is a top view of an alternative shielding arrangement on an SOI structure, using two separate shielding elements in association with the receiver circuitry; and

FIG. 11 is a cut-away side view of an exemplary SOI structure including the metallized ground plates of the present invention, including additional metallized vias formed through the SOI structure to provide an additional connection between the ground plane and the ground plates.

### DETAILED DESCRIPTION

In order to simultaneously achieve an EMI/EMC shield and optical coupling for a silicon-based opto-electronic integrated circuit formed within an SOI structure, a very low electrical impedance arrangement at electro-magnetic frequencies is required. The interface for the optical coupling also needs to be tightly controlled in order to provide the requisite evanescent coupling between a free space optical beam coupler and the SOI structure. As discussed above, the EMI/EMC shield needs to be such that, for example, an electronic transmitter circuit is significantly electro-magnetically isolated from electronic receiver circuitry (and vice versa). Additionally, the structure needs to electro-magnetically isolate the opto-electronic circuits from external, unwanted EMI radiation sources. It is to be noted that the structural requirements for EMI shielding and EMC shielding are essentially equivalent and will be treated as such for the purposes of the present invention. The EMC shield is required to prevent the transceiver from emitting electromagnetic radiation above acceptable levels. The EMI shield is required to prevent undesired external electromagnetic radiation from adversely impacting the performance of the device. In addition, EMI and EMC shielding is required in the case of an optical transceiver to prevent the transmit function of the transceiver from adversely affecting the associated receive function. It is to be understood that the shielding arrangement of the present invention is not limited to use with a transceiver arrangement, but is more generally applicable for use with virtually any opto-electronic circuit whose operation is sensitive to the presence of electromagnetic radiation (or, alternatively, generates such radiation).

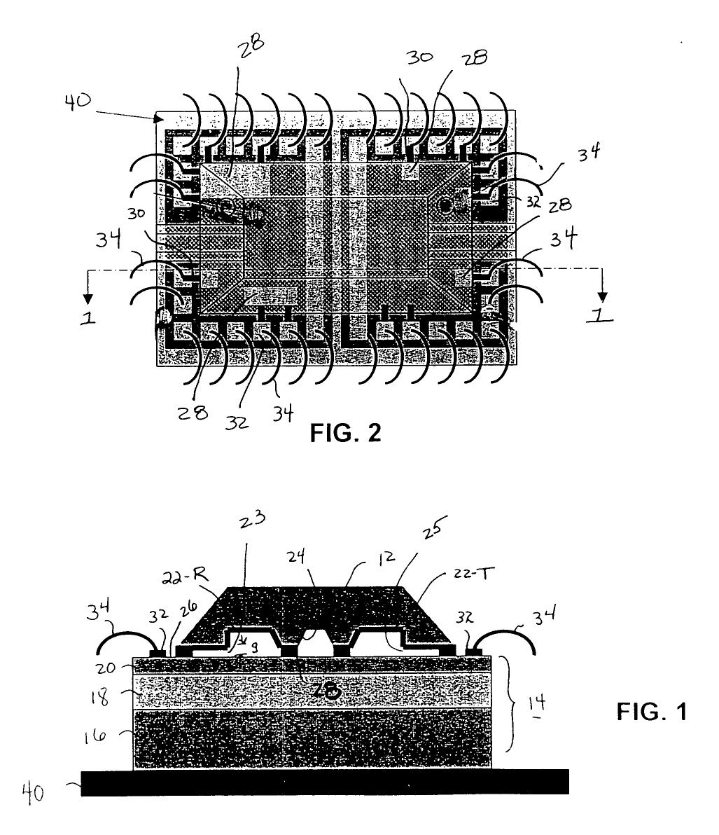

FIG. 1 illustrates an exemplary optical transceiver arrangement 10 formed in accordance with the present invention, where an optical coupling element 12 is metallized prior to attachment to an SOI structure 14, the metallization forming an EMI/EMC shield. SOI structure 14 is illustrated as comprising a bulk silicon substrate 16, an isolating (dielectric) layer 18 (usually formed of SiO₂), and a surface silicon layer 20. As becoming known in the opto-electronic SOI art, surface silicon layer 20 (also variously referred to as the “SOI layer”) is used to support the formation of the various optical and electronic components, in this case the transmitter and receiver electronic components, optical modulator and photodetecting optics required to form optical transceiver arrangement 10. In accordance with the present invention, a first metal layer 22 is deposited over the bottom, non-planar side 24 of optical coupling element 12 to form an EMI/EMC shield. First metal layer 22 may be formed as one continuous sheet across non-planar side 24 of optical coupling element 12. Alternatively, first metal layer 22 can be formed to include two discrete sections, a first section 22-R disposed so as to overly the location of the receiver electronics formed in SOI layer 20 and a second section 22-T disposed so as to overly the location of the transmitter electronics within SOI layer 20. In either case, and as will be discussed further below, an electrical connection is required between first metal layer 22 and a bona fide RF ground plane in order to provide the desired shielding.

Of course, transparent openings are required to be formed at the appropriate locations along first metal layer 22 to allow for a propagating optical signal to be coupled between optical coupling element 12 and SOI layer 20 of SOI structure 14. Moreover, the thickness of first metal layer 22 needs to be well controlled, so that the spacing (gap) g between non-planar side 24 of optical coupling element 12 and top surface 26 of surface silicon layer 20 at regions 23 and 25 is within the range required to provide evanescent optical coupling between optical coupling element 12 and SOI layer 20. It has been found that a metal layer on the order of ≦10 μm provides the desired amount of EMI/EMC shielding, while not perturbing the degree of optical coupling between optical coupling element 12 and SOI layer 20.

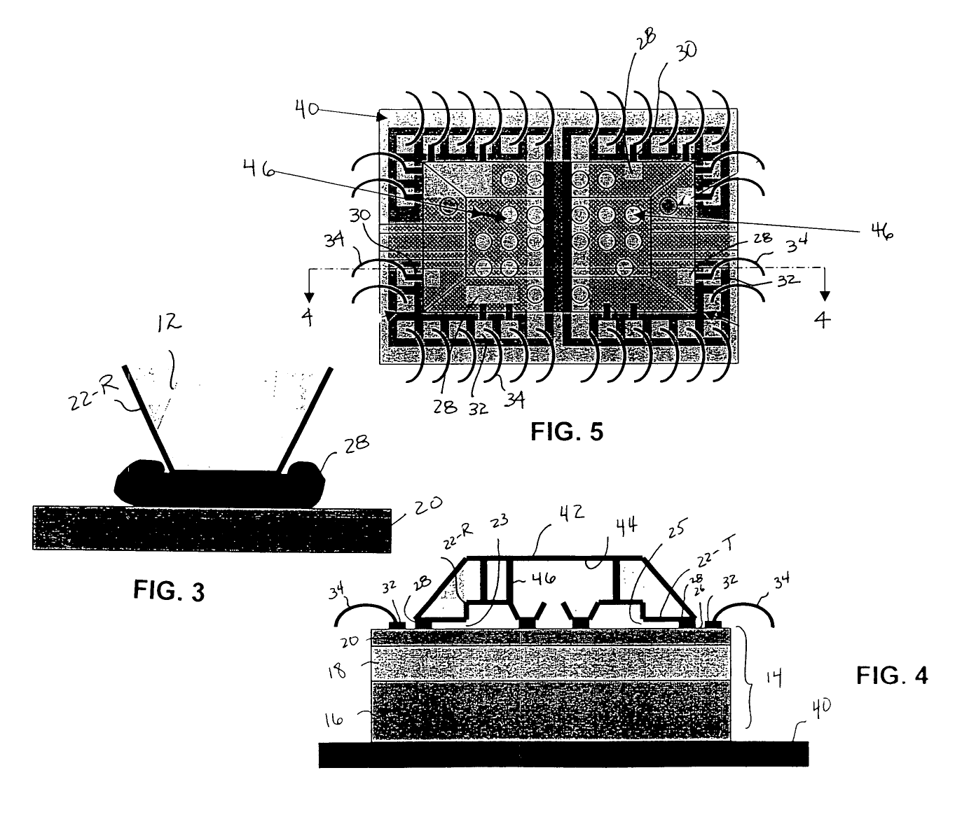

While remaining mindful of the need to tightly control the thickness of first metal layer 22, the need remains to provide a sound electrical contact between first metal layer 22 and an RF ground plane 40 on SOI structure 14. In the embodiment as illustrated in FIG. 1, an electrical contact is made at bond pads 28 around the perimeter of top surface 26 of SOI structure 14. FIG. 2 contains a top view of this structure, illustrating in detail the placement and location of the various bond pads 28, and FIG. 3 is an exploded view of one exemplary contact, illustrating the pliability of bond pad 28. Indeed, as shown in FIG. 3, a portion of optical coupling element is recessed within bond pad 28 as contact is made. Referring back to FIGS. 1 and 2, a set of metal leads 30 provides an electrical connection between bond pads 28 and outer contact bond pads 32, where a set of bond wires 34 is then used to provide the final electrical connection between first metal layer 22 and ground plane 40 disposed underneath SOI structure 14.

Various wafer-to-wafer bonding techniques are well-known in the art and may be used to join optical coupling element 12 to SOI structure 14 and affect the electrical connection between first metal layer 22 and bond pads 28 on SOI structure 14. Regardless of the bonding technique that is used, there are two requirements that need to be simultaneously met: (1) physical/electrical contact between first metal layer 22 and bond pads 28 to form the desired RF shielding; and (2) well-controlled spacing in the optical coupling regions so that evanescent coupling occurs into and out of SOI layer 20. In some cases, a separate layer of relatively low index material is used as an evanescent coupling layer, providing physical contact in the evanescent coupling regions. In this event, the metal portions of the electrical contacts are heated to a re-flow temperature and then cooled to form the electrical contacts. In other cases, a relatively thick metallic layer and/or bond pads may be used and heated to become pliable, where the two components are then pressed together to form the electrical contact and provide the desired spacing required for optical evanescent coupling.

As mentioned above, a second metal layer 42 may be formed over top surface 44 of optical coupling element 12 and used to provide additional EMI/EMC shielding. FIGS. 4 and 5 illustrate this particular embodiment of the present invention, where FIG. 4 is a side view of an exemplary structure and FIG. 5 is a top view. As shown, second metal layer 42 is formed so as to cover essentially all of top surface 44 (except for predetermined locations required to remain transparent for the passage of the optical signals, as will be discussed below). In a situation where second metal layer 42 is used to provide additional shielding, it is necessary to somehow couple second metal layer 42 to first metal layer 22 in order to maintain the integrity of the ground. One arrangement for providing this connection is to use a plurality of metallized vias 46, formed through the thickness of optical coupling element 12 to provide a conduction path between first metal layer 22 and second metal layer 44. The number and location of vias 46 may vary, as desired. One particular arrangement is illustrated in FIGS. 4 and 5, where the location of vias 46 is particularly evident in the top view of FIG. 5.

One known method of forming optical coupling element 12 is the use of standard silicon MEMS techniques. Metal deposition, optical-quality prism fabrication and metallized thru-hole vias are capabilities that all currently exist within this process and thus may be used to form a metallized optical coupling arrangement for EMI/EMC shielding in accordance with the present invention. The optical-quality prism fabrication can be achieved by a variety of methods including, but not limited to, the use of a wet anisotropic etch or gray scale lithography, as long as the mode angle for evanescent coupling is achieved.

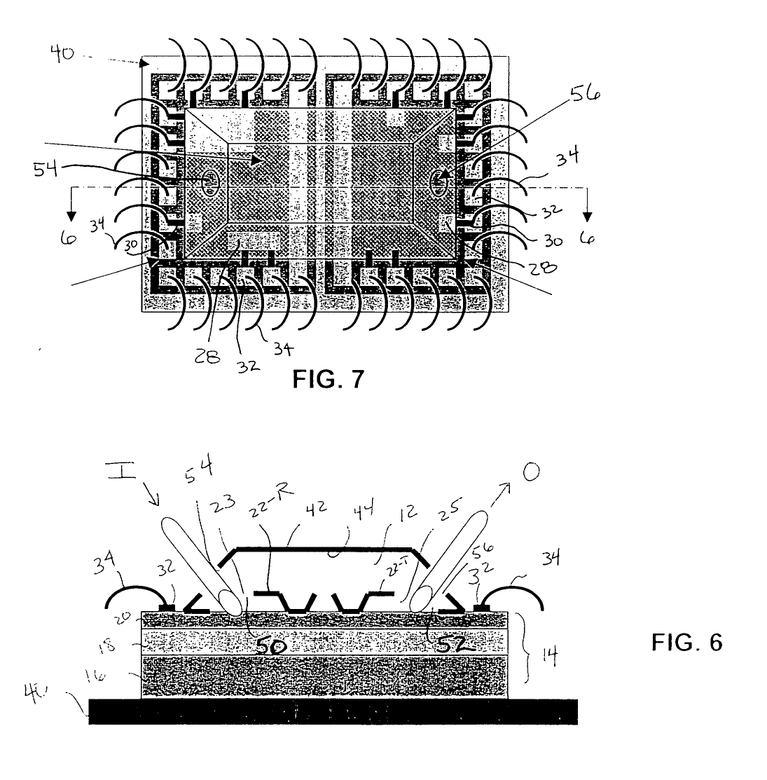

As mentioned above, it is an obvious requirement to maintain transparent “windows” in the metal layer(s) of optical coupling element 12 in order to allow for the free space optical signals to easily pass therethrough and into/out of SOI layer 20 of SOI structure 14. FIGS. 6 and 7 contain a side view and top view, respectively, of one arrangement of the embodiment of FIGS. 4 and 5 that particularly illustrate the formation of such transparent openings in first metal layer 22 and second metal layer 42. As shown, first metal layer 22 is formed to include a pair of transparent apertures 50 and 52, where transparent aperture 50 is formed in an appropriate location so as to allow for an input free space optical beam to be evanescently coupled into SOI layer 20. In a similar manner, transparent aperture 52 is formed in a location so as to allow for an optical signal propagating along SOI layer 20 to be coupled out of the waveguiding region and back into silicon optical coupling element 12 (and thereafter exiting optical coupling element 12). In most cases, the dimensions of transparent apertures 50, 52 will be less than 300 μm in diameter. If second metal layer 42 is present, another set of transparent apertures will be required, where FIGS. 6 and 7 illustrate the presence of transparent apertures 54, 56 formed within second metal layer 42, where the dimensional requirements for these apertures is necessarily the same as for apertures 50, 52. Using standard EMI shielding assumptions of gaps no larger than 1/20 of a wavelength, effective shielding will be maintained out to frequencies of 50 GHz. The effective shielding frequency range can be even further extended, in accordance with the present invention, by reducing the dimensions of the apertures to a minimally acceptable opening.

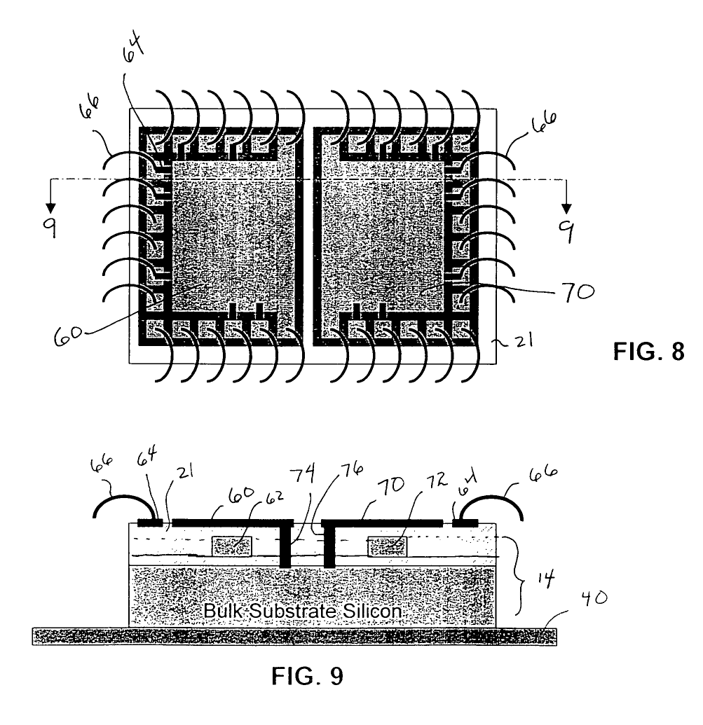

The EMI/EMC shielding arrangement of the present invention may be further improved by adding a metallic shielding arrangement to SOI structure 14 itself. The use of such an RF shield will increase the EMI/EMC performance of the optical transceiver integrated circuit formed within SOI structure 14 and, advantageously, may easily be incorporated into the processing steps used to fabricate the transceiver circuitry itself. FIG. 8 is a top view of SOI structure 14 including the opto-electronic elements required to form an exemplary optical transceiver (obviously, various other EMI-sensitive opto-electronic circuits may also be formed within SOI structure 14, the transceiver being considered as just one example). FIG. 9 is a cut-away side view of the same structure, taken along line 9-9 of FIG. 8. The optical and electrical components required to form the optical transceiver structure are contained within SOI layer 20, where an overlying dielectric region 21 is formed to completely cover and electrically isolate the circuitry formed within SOI layer 20. In accordance with this embodiment of the present invention, a first RF ground plane shield 60 is disposed over that portion of SOI structure 14 associated with the position of receiver circuitry 62. Receiver ground plane 60 is connected to a plurality of receiver RF ground bond pads 64, where an associated plurality of bonds 66 are then coupled to ground plane 40 formed underneath SOI structure 14, as particularly shown in FIG. 9.

A second RF ground plane shield 70 may be disposed over that portion of SOI structure 14 associated with the position of transmitter circuitry 72. FIGS. 8 and 9 illustrate the location of second shield 70, which is coupled in a similar manner through a set of bonds to ground plane 40. In fabrication, first and second RF ground planes 60 and 70 may, in one embodiment, comprise a single metallic layer. Alternatively, separate metallic regions may be formed. Separate ground planes will typically enable better isolation between the optical transmitter and receiver sections, but will exhibit poorer EMI and EMC performance than a single RF ground plane. Indeed, implementation of a single or dual RF ground plane(s) will be dependent upon overall device performance requirements. A metallized via 74 is used to couple first ground plane 60 to the bulk silicon material of substrate 16, with a similar metallized via 76 used to couple second ground plane 70 to substrate 16. This coupling further improves the shielding provided by the arrangement of the present invention. In general, various and separate RF ground planes may be formed and disposed to shield any surface area containing EMI-sensitive electronic components.

As mentioned above, ground planes 60 and 70 are formed during the integrated circuit fabrication process utilized to form the transceiver opto-electronic components, using a conventional metallization process. The metallization thickness in this process is typically 2 μm thick, but other thicknesses may be used. As is well known, multiple levels of metal are typically formed in the silicon structure during the integrated circuit fabrication process. Advantageously, additional ground planes can be added at these metal layers to increase the overall shielding effectiveness. These additional metal layers must be electrically connected in order to provide the requisite shielding. Inter-level metallization connections are known and can be used to provide this desired electrical connection.

As discussed above, a receiver RF ground plane shield may be designed to shield the most sensitive circuitry. In the receiver circuitry, the front-end pre-amplifier stage (transimpedance amplifier—TIA) of the receiver includes the most sensitive circuitry. The utilization of an RF shield over this front-end stage in accordance with the present invention will help its EMI performance, but may degrade the overall sensitivity performance of the TIA stage in the absence of an EMI source. The amount of isolation degradation will depend on whether the RF shield and its connection to the RF ground are a true RF ground potential. This electrical connection has the potential to be very difficult to implement, due to the relative thinness of the RF ground plane shield (i.e., ≦2 μm), where this relatively thin shield results in generating parasitic inductances, capacitances and resistances. Depending on the implementation, these parasitics may cause the shield to act as an antenna at high frequencies. The parasitics may be reduced by utilizing a large number of RF ground bond pads 64, as shown in FIG. 8. A plurality of properly-placed and spaced bond pads 64 will function to reduce the parasitic values. Increasing the thickness of RF ground plane 60 will also function to reduce the parasitic values.

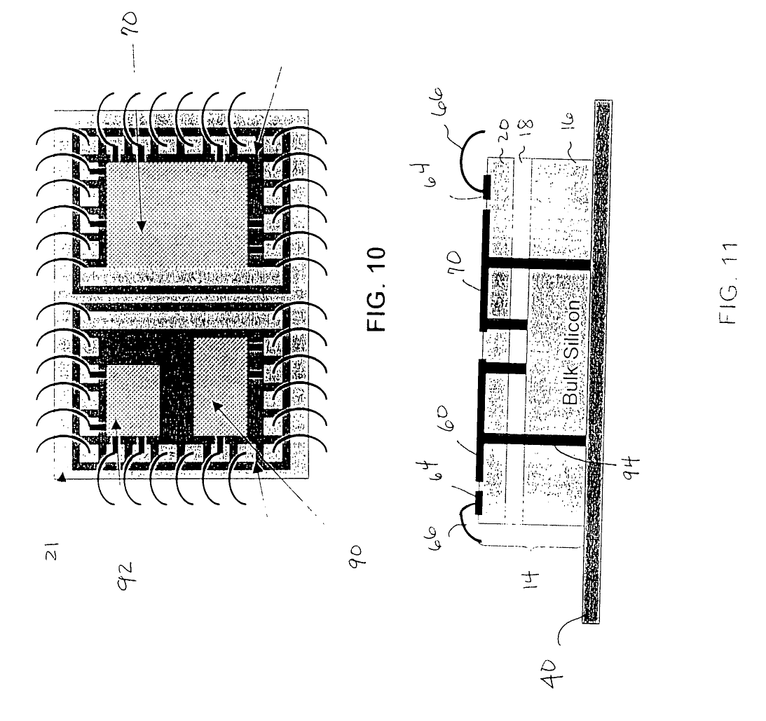

FIG. 10 contains a top view of an alternative embodiment of the present invention, in this case having a first receiver RF ground plane 90 disposed over the location of a front-end pre-amplifier (TIA) stage, with a second receiver RF ground plane 92 disposed over the back-end of the receiver (typically referred to as the “post amplifier” portion). The same transmitter RF ground plane 70 as described above may be used. In this arrangement, the receiver will exhibit a higher gain than the arrangement as shown in FIGS. 8 and 9.

Additional isolation and EMI/EMC performance may be achieved, in accordance with the present invention, by extending metallized RF ground vias from the shield planes through the depth of SOI structure 14. FIG. 11 is a cut-away side view of an exemplary arrangement of the present invention, incorporating metallized vias 94 and 96 that extend from first and second RF ground planes 60 and 70, respectively, through the entire thickness of silicon substrate 16 so as to contact ground plane 40.

The foregoing preferred embodiments are intended to illustrate, rather than limit, the scope of the present invention. Those skilled in the art will recognize that these embodiments may be modified without departing from the spirit and scope of the present invention as defined by the claims appended hereto:

1. An opto-electronic circuit arrangement based on a silicon-on-insulator (SOI) structure, the opto-electronic circuit arrangement comprising
silicon-based electronic circuitry formed within at least a portion of a surface SOI layer, wherein at least a portion of the silicon-based electronic circuitry requires electromagnetic radiation shielding;
at least one optical component formed within the SOI layer; and
an optical coupling element disposed over the SOI structure for coupling optical signals into and out of the at least one optical component within the SOI layer, the optical coupling element including a first metallized layer on the surface interfacing with the SOI layer, the metallized layer coupled to a ground plane for providing shielding for the opto-electronic circuit arrangement, the metallized layer including transparent apertures for allowing optical signals to pass therethrough.

2. The opto-electronic circuit arrangement of claim 1 wherein the optical coupling element first metallized layer is formed as a single, continuous layer disposed to overly regions of the SOI layer containing electronic circuitry.

3. The opto-electronic circuit arrangement of claim 1 wherein the optical coupling element first metallized layer is formed as at least two separate sections, a first section disposed to shield electronic circuitry whose performance is sensitive to electromagnetic radiation.

4. The opto-electronic circuit arrangement of claim 3 wherein the shielded electronic circuitry comprises electronic receiver circuitry.

5. The opto-electronic circuit arrangement of claim 1 wherein the first metallized layer comprises a second section disposed to shield electronic circuitry that generates electromagnetic radiation.

6. The opto-electronic circuit arrangement of claim 5 wherein the shielded electronic circuitry comprises electronic transmitter circuitry.

7. The opto-electronic circuit arrangement of claim 1 wherein the circuit arrangement comprises a transceiver and the electronic circuitry comprises receiver circuitry formed in a first section of the SOI layer and transmitter circuitry formed in a second section of the SOI layer, the optical coupling element first metallized layer formed to at least cover the first section of the SOI layer.

8. The opto-electronic circuit arrangement of claim 1 wherein the optical coupling element comprises a prism coupler, disposed a predetermined distance above the SOI layer so as to provide for evanescent optical coupling into and out of the SOI layer of the SOI structure.

9. The opto-electronic circuit of claim 1 wherein the optical coupling element further comprises a second metallized layer disposed over the outer surface of the optical coupling element and electrically contacted to the first metallized layer, the second metallized layer providing additional electromagnetic radiation shielding.

10. The opto-electronic circuit of claim 9 wherein the optical coupling element further comprises metallized vias formed through the extent of said optical coupling element to form an electrical connection between the first and second metallized layers.

11. The opto-electronic circuit of claim 1 wherein the opto-electronic circuit further comprises
a first metallized layer formed over at least a portion of the SOI layer containing electromagnetic radiation-sensitive electronics, the first metallized layer contacted to an external ground plane to provide additional electromagnetic shielding.

12. The opto-electronic circuit of claim 11 wherein the first metallized layer comprises a single, continuous layer formed to cover a major portion of the electromagnetic radiation-sensitive electronics.

13. The opto-electronic circuit of claim 11 wherein the first metallized layer comprises at least two separate sections, a first section disposed over a first portion of the electromagnetic radiation-sensitive electronics and a second section disposed over a second portion of the electromagnetic radiation-sensitive electronics, the first and second sections separately connected to the external ground plane.

14. The opto-electronic circuit of claim 11 wherein the opto-electronic circuit further comprises
a second metallized layer formed over at least a portion of the SOI layer containing electromagnetic radiation-generating electronics, the second metallized layer contacted to the external ground plane to provide additional electromagnetic radiation shielding.

15. The opto-electronic circuit of claim 11 wherein the opto-electronic circuit further comprises at least one metallized via disposed through the SOI structure to electrically connect the first metallized layer to the external ground plane.

16. The opto-electronic circuit of claim 1 wherein the optical coupling element first metallized layer comprises a thickness of no greater than 10 microns.
